(19) United States
(12) Patent Application Publication
(10) Pub. No.: US 2002/0174020 A1
(43) Pub. Date: Nov. 21, 2002

(54) Method and apparatus for conducting a transaction

(76) Inventors: William Grey, Millwood, NY (US); Clifford A. Pickover, Yorktown Heights, NY (US); Paul A. Moskowitz, Yorktown Heights, NY (US); Dailun H. Shi, Croton on Hudson, NY (US)

Correspondence Address: BUCKLEY, MASCHOFF, TALWALKAR, & ALLISON, 5 ELM STREET, NEW CANAAN, CT, 06840, US

(21) Appl. No.: 09/855,475

(22) Filed: May 15, 2001

(51) Int. Cl. G06F 17/60

(52) U.S. Cl. 705/26; 705/39

(57) ABSTRACT

A system, method, apparatus, and computer program code for conducting a transaction where one or more rules may be applied when an entity is conducting the transaction. Rules may vary by entity, product, transaction and/or the marketplace where the transaction is being conducted.

### CROSS-REFERENCE TO RELATED PATENT APPLICATIONS

This patent application is related to co-pending patent application entitled Method and Apparatus for Establishing Multiple Transactions to Fulfill a Requirement Involving a Product, which has application Ser. No. ______ and was filed on May 15, 2001, and to co-pending patent application entitled Method and Apparatus for Conducting Multiple Transactions, which has application Ser. No. ______ and was filed on May 15, 2001, both of which are incorporated herein by reference.

### FIELD OF THE INVENTION

The present invention relates to a method and apparatus for conducting a transaction and, more particularly, embodiments of the present invention relate to methods, apparatus, and computer program code for applying a rule during a transaction, the rule being associated with the transaction and/or one or more entities or marketplaces involved in the transaction.

### BACKGROUND OF THE INVENTION

A company or an individual may conduct a large number of transactions for the purchase and sale of products at a large number of marketplaces. Different terms and conditions may apply to different transactions. Moreover, an entity conducting multiple transactions at multiple marketplaces may have different terms available for two or more of the transactions. In some situations, as seen frequently in financial markets or markets involving dynamically priced products, a sale or purchase of a large quantity of products may have an impact on the price for the products sold or purchased. Thus, the seller or purchaser may have little ability to plan for or estimate the price variations.

It would be advantageous to provide a method and apparatus that overcame the drawbacks of the prior art. In particular, it would be desirable to provide a method and apparatus for allowing an entity (e.g., buyer, seller, supplier, manufacturer, distributor) conducting a transaction (e.g., purchase or sale of a product) to use one or more rules that have been established for the entity or a marketplace involved in the transaction to allow the entity to receive certain benefits.

### SUMMARY OF THE INVENTION

Embodiments of the present invention provide a system, methods, apparatus, and computer program code for conducting one or more transactions on behalf of one or more entities and/or one or more marketplaces. According to embodiments of the present invention, each of a plurality of entities (e.g., buyers, sellers, distributors, manufactures) are assigned one or more rules. A rule may provide a benefit to the entity when the entity conducts a transaction (e.g., sells a product, buys a product). A rule may have a condition and a benefit or other result associated with it, the condition needing to be satisfied before the benefit or other result can be applied. When one of the entities conducts a transaction, the entity or another entity or device may determine if one of the rules applies to the transaction. Additional objects, advantages, and novel features of the invention shall be set forth in part in the description that follows, and in part will become apparent to those skilled in the art upon examination of the following or may be learned by the practice of the invention. As used herein, the term “product” shall include any tangible or intangible product or service. In some embodiments, a product may be limited to a non-financial product or a dynamically price product.

According to embodiments of the present invention, a method for conducting a transaction includes associating a plurality of rules with a respective plurality of entities; determining that one of the entities is conducting a transaction; determining one of the rules that is associated with the entity regarding the transaction; and conducting the transaction in accordance with the rule. In another embodiment, a method for facilitating a transaction includes associating a first rule governing a first transaction with a first entity, wherein a first marketplace will honor the first rule when the first entity conducts the first transaction at the first marketplace; associating a second rule governing a second transaction with a second entity, wherein a second marketplace will honor the second rule when the second entity conducts the second transaction at the second marketplace; and authorizing application of the first rule when the first entity conducts the first transaction at the first marketplace and application of the second rule when the second entity conducts the second transaction at the second marketplace. In a further embodiment, a method for facilitating a transaction includes associating a plurality of rules with a respective plurality of entities; receiving a notification of a transaction involving one of the entities; determining one of the rules that is associated with the transaction; and providing a notification of the determined rule. In yet another embodiment, a method for conducting a transaction includes associating a first rule governing a first transaction with a first entity and a second rule governing a second transaction with a second entity; receiving a notification of the first entity conducting the first transaction; and applying the first rule when the first entity conducts the first transaction. In still another embodiment, a method for facilitating a transaction includes receiving a notification of a transaction involving a product; determining a rule that is associated with the transaction; and providing a notification of the rule. In another embodiment, a method for facilitating a transaction includes determining a rule associated with a product; determining a plurality of transactions that satisfies the rule; and applying the rule to at least one of the transactions.

According to one embodiment of the present invention, a system for facilitating a transaction includes a memory; a communication port; and a processor connected to the memory and the communication port, the processor being operative to: associate a plurality of rules with a respective plurality of entities; determine that one of the entities is conducting a transaction; determine one of the rules that is associated with the one of the plurality of entities regarding the transaction; and authorize the transaction in accordance with the rule. In another embodiment, the processor may be operative to associate a first rule governing a first transaction with a first entity, wherein a first marketplace will honor the first rule when the first entity conducts the first transaction at the first marketplace; associate second rule governing a second transaction with a second entity, wherein a second marketplace will honor the second rule when the second entity conducts the second transaction at the second marketplace; and authorize application of the first rule when the first entity conducts the first transaction at the first marketplace and application of the second rule when the second entity conducts the second transaction at the second marketplace. In a further embodiment, the processor may be operative to associate a plurality of rules with a respective plurality of entities; receive a notification of a transaction involving one of the entities; determine one of the rules that is associated with the transaction; and provide a notification of the determined rule. In yet another embodiment, the processor may be operative to associate a first rule governing a first transaction with a first entity and a second rule governing a second transaction with a second entity; receive a notification of the first entity conducting the first transaction; and apply the first rule when the first entity conducts the first transaction. In still another embodiment, the processor may be operative to receive a notification of a transaction involving a product; determine a rule that is associated with the transaction; and provide a notification of the rule. In another embodiment, the processor may be operative to includes determine a rule associated with at least one product; determine a plurality of transactions that satisfies the rule; and apply the rule to at least one of the transactions.

According to one embodiment of the present invention, an apparatus for conducting a transaction includes means for establishing a plurality of rules with a respective plurality of entities; means for identifying that one of the entities is conducting a transaction; means for identifying one of the rules that is associated with the entity regarding the transaction; and means for completing the transaction in accordance with the rule. In another embodiment, an apparatus for facilitating a transaction includes means for establishing a first rule governing a first transaction with a first entity, wherein a first marketplace will honor the first rule when the first entity conducts the first transaction at the first marketplace; means for establishing a second rule governing a second transaction with a second entity, wherein a second marketplace will honor the second rule when the second entity conducts the second transaction at the second marketplace; and means for applying of the first rule when the first entity conducts the first transaction at the first marketplace and application of the second rule when the second entity conducts the second transaction at the second marketplace. In a further embodiment, an apparatus for facilitating a transaction includes means for establishing a plurality of rules with a respective plurality of entities; means for obtain a notification of a transaction involving one of the entities; means for identifying one of the rules that is associated with the transaction; and means for sending a notification of the determined rule. In yet another embodiment, an apparatus for conducting a transaction includes means for establishing a first rule governing a first transaction with a first entity and a second rule governing a second transaction with a second entity; means for obtaining a notification of the first entity conducting the first transaction; and means for authorizing use of the first rule when the first entity conducts the first transaction. In still another embodiment, an apparatus for facilitating a transaction includes means for obtaining a notification of a transaction involving a product; means for identifying a rule that is associated with the transaction; and means for sending a notification of the rule. In another embodiment, an apparatus for facilitating a transaction includes means for identifying a rule associated with a product; means for identifying a plurality of transactions that satisfies the rule; and means for using the rule to conduct at least one of the transactions.

According to one embodiment of the present invention, a computer program product in a computer readable medium for facilitating a transaction includes first instructions for establishing a respective rule for each of a plurality of entities; second instructions for identifying one of the plurality of entities conducting a transaction; third instructions for identifying a rule associated with the one of the plurality of entities; and fourth instructions for sending an authorization of the transaction in accordance with the rule. In another embodiment, a computer program product in a computer readable medium for facilitating a transaction includes first instructions for establishing a first rule governing a first transaction with a first entity, wherein a first marketplace will honor the first rule when the first entity conducts the first transaction at the first marketplace; second instructions for establishing a second rule governing a second transaction with a second entity, wherein a second marketplace will honor the second rule when the second entity conducts the second transaction at the second marketplace; and third instructions for applying of the first rule when the first entity conducts the first transaction at the first marketplace and application of the second rule when the second entity conducts the second transaction at the second marketplace. In a further embodiment, a computer program product in a computer readable medium for facilitating a transaction includes first instructions for establishing a plurality of rules with a respective plurality of entities; means for obtain a notification of a transaction involving one of the entities; second instructions for identifying one of the rules that is associated with the transaction; and third instructions for sending a notification of the determined rule. In yet another embodiment, a computer program product in a computer readable medium for conducting a transaction includes first instructions for establishing a first rule governing a first transaction with a first entity and a second rule governing a second transaction with a second entity; second instructions for obtaining a notification of the first entity conducting the first transaction; and third instructions for authorizing use of the first rule when the first entity conducts the first transaction. In still another embodiment, a computer program product in a computer readable medium for facilitating a transaction includes first instructions for obtaining a notification of a transaction involving a product; second instructions for identifying a rule that is associated with the transaction; and third instructions for sending a notification of the rule. In another embodiment, a computer program product in a computer readable medium for facilitating a transaction includes first instructions for identifying a rule associated with a product; second instructions for identifying a plurality of transactions that satisfies the rule; and third instructions for using the rule to conduct at least one of the transactions.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a flowchart of a fourth embodiment of a method in accordance with the present invention;

FIG. 5 is a block diagram of system components for an embodiment of an apparatus usable with the methods of FIGS. 1-4;

FIG. 6 is a block diagram of components for an embodiment of a server of FIG. 5;

FIG. 7 is an illustration of a representative entity database of FIG. 6;

FIG. 8 is an illustration of a representative rule database of FIG. 6; and

FIG. 9 is an illustration of a representative marketplace database of FIG. 6.

### DETAILED DESCRIPTION

Applicants have recognized that there is a need for systems and methods that allow a person, company, marketplace or other entity conducting a transaction or otherwise involved in a transaction to take advantage or use a rule associated with the entity or transaction. For example, a rule may allow a company purchasing products at a particular marketplace to receive a ten percent (10%) discount on the purchase. As another example, a rule may allow a company completing a series of transactions to receive a retroactively applied discount to all of the transactions. As a third example, a rule may allow a company purchasing a product to receive the average spot price for a product for the previous month. A transaction may involve the purchase or sale of a product at one or more marketplaces. An entity involved in a transaction might be a seller, purchaser, distributor, supplier, manufacturer, etc. of a product or service. Both “products” and “services” will hereinafter be referred to as “products.” In addition, as used herein, the term “product” will include any intangible or tangible good, item or service. In some embodiments, a product may be limited to a non-financial product or to a dynamically price product.

A marketplace may be or include any kind of “brick and mortar” marketplace or exchange, such as a store, warehouse, flea market, auction house, public or private exchange, etc. and/or any kind of online marketplace, such as an auction oriented Web site (e.g., www.ebay.com), bulletin board, exchange, product supplier (e.g., www.amazon.com), etc. A marketplace might include any person, company or other entity that allows or enables a purchaser and a seller to negotiate or conduct a transaction. A marketplace may be a buyer-side marketplace, a seller-side marketplace or a two-sided marketplace. Information regarding one or more marketplaces might be stored in, or accessed from, a marketplace information database.

By allowing an entity to take advantage of a rule, stronger associations can be created between the company and a marketplace or between two entities (e.g., a buyer of a product and a seller of the product). In addition, a service provider can coordinate the rules on behalf of one or more companies or other entities and/or one or more marketplaces. These and other features will be discussed in further detail below, by describing a system, individual devices, and processes according to embodiments of the invention.

Process Description

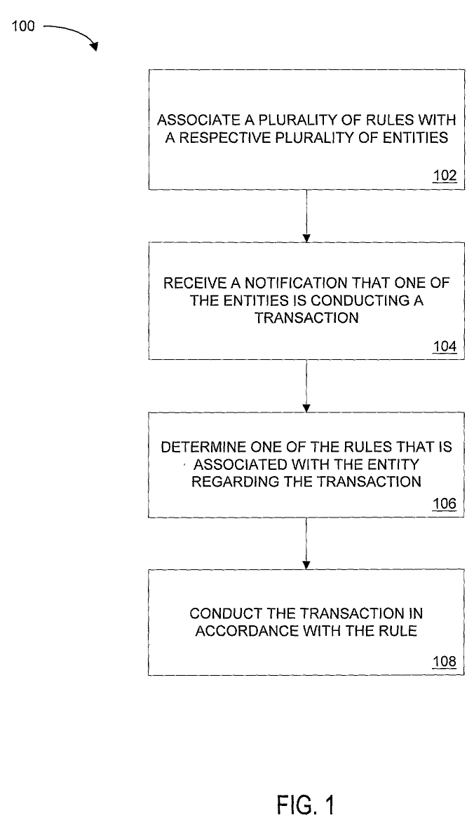

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be implemented by a server or other device on behalf of one or more entities.

Processing begins at a step 102 where a plurality of rules are associated with a plurality of entities. Entities may include sellers, buyers, suppliers, distributors, manufacturers, etc., of a product and marketplaces where a product can be bought, sold, ordered, reserved, etc. Information regarding one or more rules might be stored in, or accessed from, a database.

A rule may provide one or more benefits or other results to an entity. For example, a rule may allow an entity to receive a price discount when purchasing or selling a product, to receive the best price for the product offered to any purchaser of the product, etc. As another example, a rule could establish that a customer receives a price for a product that is ninety percent (90%) of the current spot price for the product when the customer purchases the product. In other examples, a rule might provide a benefit based on the average market price for a product over a period of time or over several time periods; an average, minimum or maximum price for a product over a time period; a function of market prices of a product over a time period; etc.

A rule may be based on or linked to a number of things, including, but not limited to: a barter credit; a spot, minimum, maximum, average or other price of a product involved in a transaction; a minimum or maximum number of products purchased during a transaction; a quality, availability, payment, shipping, delivery, payment or packaging term or requirement associated with a transaction and/or a product; market or spot price for a product; an amount of inventory of a product involved in a transaction; availability of a product involved in a transaction, etc.

In some embodiments, a rule may be established such that the rule can be used or applied only a limited or fixed number of times before the rule expires or is no longer usable or applicable. Thus, in some embodiments a rule might have an associated rule count that tracks or monitors how many times a rule has been applied. In other embodiments, a specific expiration date might be established for a rule. A rule may be modified over time if the rule is not used or applied, if the rule is used or applied a designated number of times, as a result of some external event (e.g., an oversupply of a product, a demise or bankruptcy of a buyer or seller of a product).

In some embodiments, a condition and a result might be established for a rule or otherwise associated with a rule. The condition may need to be satisfied before the result is available or applicable. For example, a purchaser may need to purchase a minimum number of units of a product to be entitled to a rule that provides price discounts for the product. As another example, a rule might require that a minimum cumulative purchasing volume be obtained during a specified time period in order for price discounts to apply. Once the cumulative volume is reached, the price discounts may be applied to future purchases and/or retroactively applied to previous purchases. Thus, the condition has a benefit associated with it that is applied as part of its associated rule when the condition is met.

A condition associated with a rule might include one or more of the following: a requirement that a minimum or maximum number or quantity of products be purchased as part of a transaction; a requirement of a predetermined lead time between a transaction and delivery of a product involved in the transaction; a requirement of a predetermined lead time between a transaction and shipping of a product involved in the transaction; a requirement for a cumulative transactional volume over a designated time period; a requirement for a cumulative transactional volume by a specific entity; a requirement for a cumulative transactional volume at a designated marketplace; a requirement for a minimum availability of a product involved in a transaction; a requirement for an insurance policy associated with a transaction; a requirement of a minimum or maximum financial amount involved in a transaction; a requirement of a designated security associated with a transaction; a quality requirement for a product involved in a transaction; a requirement of agreement to a shipping, delivery, payment or packaging term; a requirement for a specific entity and/or marketplace to be involved or not involved in a transaction; etc. In some embodiments a notification may be sent or received regarding a condition associated with a rule and/or satisfaction of the condition.

A rule may be associated to an entity in a variety of ways. For example, in some embodiments a buyer of a product and a seller of a product may agree to one or more terms that will be applied to transactions between them for one or more products, to transactions occurring during a specific time or on a specific date, to transactions involving a minimum or maximum volume of a product, to transactions taking place at a specific marketplace, to transactions involving a minimum value or monetary amount, etc. A server or other device implementing the method 100 may receive a message or other notification of rule(s) established between the buyer and seller. The message or other notification may be received in any format or form, including, but not limited to, instant message communication, HTTP (Hypertext Transfer Protocol), HTML (Hypertext Mark-up Language) or FTP (File Transfer Protocol) transmission, XML (Extensible Mark-up Language) feed, email message, facsimile transmission, telephone call, electronic signal or communication, etc., and may come from any type of device, such as a server or user or client device (e.g., computer, cellular telephone).

As another example, in some embodiments a server might be conducting the method 100 on behalf of a marketplace that sells products. The server may store information regarding each transaction conducted by an entity that takes place at the marketplace and use the information the next time the entity conducts a transaction at the marketplace.

As another example, a marketplace may provide a rule or group of rules that apply to one or more transactions conducted at the marketplace by one or more entities. The rule may be associated with the entity when the entity initiates or completes a transaction or prior to the entity initiating a transaction. Thus, in some embodiments a rule might be associated with an entity without the entity's knowledge and applied by the marketplace when the entity conducts the required transaction at the marketplace. In other embodiments, the marketplace might send a message or other notification to the entity informing the entity of the availability or applicability of the rule.

During a step 104, a determination is made that one of the entities involved in the step 102 is involved in a transaction. For example, an entity, or a server or other device associated with the entity, implementing the method 100 may receive a message or other notification from an entity or a marketplace or some other party that the entity is conducting a transaction at the marketplace. In some embodiments, the message or other notification received by the server may include a code or other identifier associated with an entity, a marketplace, or a transaction involving the entity and/or marketplace. As another example, a server conducting the method 100 on behalf of an entity or marketplace may detect or monitor a transaction involving the entity and/or the marketplace or otherwise be involved in the transaction.

During a step 106, an entity, or a server or other device associated with the entity, implementing the method 100 determines one of the rules involved in the step 102 that is associated with the entity determined to be conducting a transaction during the step 104. For example, the server or other device may store information regarding rules in a rule database and information regarding entities in an entity database. After the step 104, the server or other device will know which entity is involved in a transaction and can access the rules database to determine if any rule should be applied to the transaction or if any rule is somehow related to the transaction. As another example of how the step 106 may be implemented, a server or other device might receive a message or other notification regarding an entity and which of the rules associated with the entity are to be applied with the entity and a transaction involving the entity.

During a step 108, the transaction involved in the step 104 and 106 is conducted. The transaction will be conducted in accordance with the rule determined during the step 106. In some embodiments, the step 108 may include one or more of the following: determining a product involved in the transaction; determining a minimum, maximum, average or spot price for a product involved in the transaction; verifying completion or satisfaction of a condition associated with the rule determined during the step 106; applying a barter credit to the transaction; applying a predetermined credit or payment term to the transaction; applying a predetermined discount to the transaction; determining an average, minimum, maximum or spot price for a product over a designated period of time; applying a function of market prices for a product over a designated period of time for the product when the product is involved in the transaction; providing a designated price to a product involved in the transaction; determining or providing a fulfillment priority to the transaction; determining a product bundled with the transaction; determining logistics terms for the transaction; providing a notification of the rule; providing an authorization to conduct the transaction; etc. In some embodiments, the step 108 may involve authorizing another party to conduct the transaction such that the transaction is indirectly conducted during the step 108.

In some embodiments of the method 100, a product involved in a transaction may be dynamically priced such that the product's price varies over time as marketplace fluctuations or sales or purchases of the product occur. In some embodiments of the method 100, an entity and/or marketplace may be charged a fee for one or more of the steps 102, 104, 106 or 108. Thus, the method 100 may include a step of determining the charge or fee and/or providing a message or other notification of the charge or fee. In some embodiments a charge may be based on one or more of the following: a monetary amount involved in a transaction; anticipated cost savings associated with a transaction; realized cost savings associated with a transaction; costs associated with the transaction relative to a benchmark; anticipated benefits associated with a transaction; realized benefits associated with a transaction; benefits associated with a transaction relative to a benchmark; a delivery, shipping, payment, financial credit or order requirement associated with a transaction; a number of entities in the plurality of entities; a number of transactions; a type or nature of one or more of the transactions; a product quantity or quality requirement; availability of the product involved in the transaction; a number of rules in the plurality of rules, a number of products involved in a transaction; a number of times a rule from the plurality of rules has been applied in previous transactions; a number of times an entity from the plurality of entities has been involved in previous transactions; a marketplace involved in the transaction; a transactional value or volume of a transaction; the time needed to implement one or more transactions; the time needed to implement one or more of the steps of the method 100; etc. In some embodiments, the method 100 might include a step during which a notification of the fee is provided to an entity or marketplace involved in a transaction, one or more of the transactions, etc. or the fee may be charged to one or more of the entities. In some embodiments, the method 100 also may include a step of receiving an authorization, or a notification or other data indicative of an authorization to complete one or more of the steps of the method 100 based on the fee.

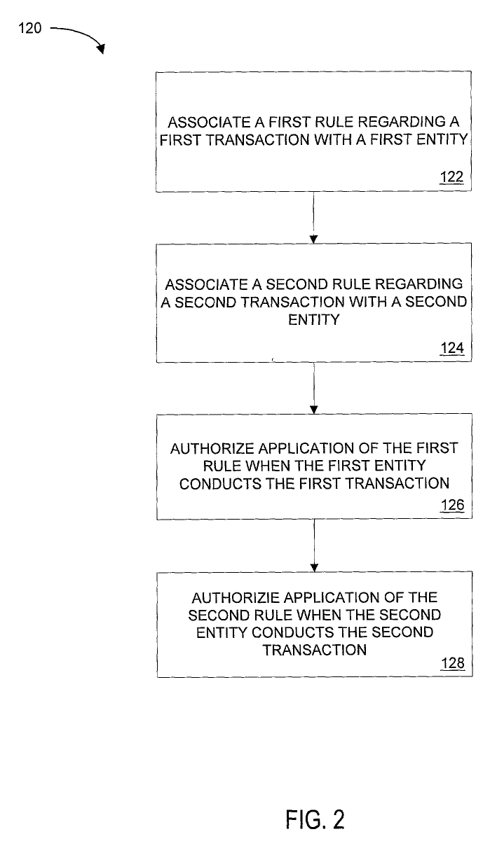

Reference is now made to FIG. 2, where a flow chart 120 is shown which represents the operation of a second embodiment of the present invention. The particular arrangement of elements in the flow chart 120 is not meant to imply a fixed order to the steps; embodiments of the present invention can be practiced in any order that is practicable. In some embodiments, some or all of the steps of the method 120 may be implemented by a server or other device on behalf of one or more entities.

Processing begins at a step 122 during which a rule regarding a transaction conducted or to be conducted is associated with a first entity. During a step 124, a rule regarding a transaction conducted or to be conducted is associated with a second entity is associated with a second entity. The rule, transaction and entity involved in the step 122 may be different from the rule, transaction and entity involved in the step 124. In some embodiments, rule and/or marketplace involved in the step 122 may be the same as the rule and/or marketplace involved in the step 124. The steps 122 and 124 are similar to the step 102 previously discussed above. As with the method 100, a rule may include an associated condition or result where the condition must be satisfied before the result is provided.

During a step 126, an authorization is provided to allow application of the rule involved in the step 122 when the first entity conducts the transaction involved in the step 122. Similarly, during a step 128, an authorization is provided to allow application of the rule involved in the step 124 when the second entity conducts the transaction involved in the step 124. For purposes of the method 120, authorizing a transaction to be conducted in accordance with a rule may include actually conducting the transaction.

In some embodiments the method 120 may include a step of receiving a message or other notification of the first entity conducting its relevant or associated transaction and/or the second entity conducting its relevant or associated transaction. The transactions involved in the steps 126, 128 may occur at different times and/or at different marketplaces. The transactions involved in the steps 126, 128 may involve different products and/or vastly different rules.

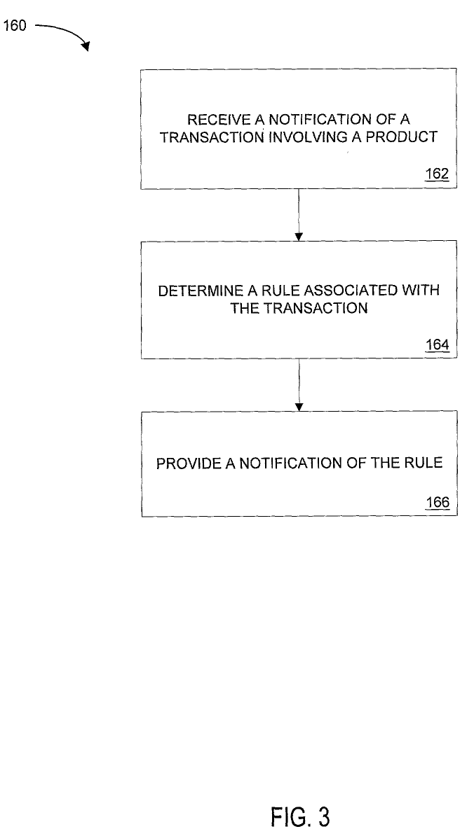

Reference is now made to FIG. 3, where a flow chart 160 is shown which represents the operation of a third embodiment of the present invention. The particular arrangement of elements in the flow chart 160 is not meant to imply a fixed order to the steps; embodiments of the present invention can be practiced in any order that is practicable. In some embodiments, some or all of the steps of the method 160 may be implemented by a server or other device on behalf of one or more entities. In some embodiments, the method 160 may be implemented by an entity or device on behalf of one or more buyers, sellers, marketplaces, etc. conducting transactions of otherwise involved in transactions.

Processing begins at a step 162 during which a message or other notification is received of a transaction involving a product. The notification might be. received from an entity involved in the transaction or another party aware of or monitoring the transaction. The message or other notification received during the step 162 be received in any format or form, including, but not limited to, HTTP, HTML or FTP transmission, XML feed, email message, facsimile transmission, instant message communication, telephone call, electronic signal or communication, etc., and may come from any type of device, such as a server or user device (e.g., computer, cellular telephone).

The notification received during the step 162 may include a variety of information regarding the transaction, including, but not limited to: a name, description or identifier of a product, marketplace or entity associated with the transaction; time/date information for the transaction; a payment, delivery, shipping, packaging or quality requirement associated with the transaction; etc.

During a step 164, a rule is determined that is associated with the transaction. For example, a rule from a group of rules may be selected automatically depending on an entity, product or marketplace involved in the transaction, the time/date of the transaction, etc. As another example, the notification received during the step 162 may include an identifier associated with the transaction or an entity involved in the transaction. A transaction, entity, or rule database may store information regarding which rule is associated with the identifier. By accessing the appropriate database, the rule associated with the identifier (and hence the transaction) can be identified.

During a step 166, a notification is provided regarding the rule. The notification can be in any form or format. If the method 160 is implemented by an entity or device on behalf of one or more buyers, sellers, marketplaces, etc. conducting transactions of otherwise involved in transactions, the notification provided during the step 166 may be sent to one of those parties involving them of a rule to be used with a particular transaction.

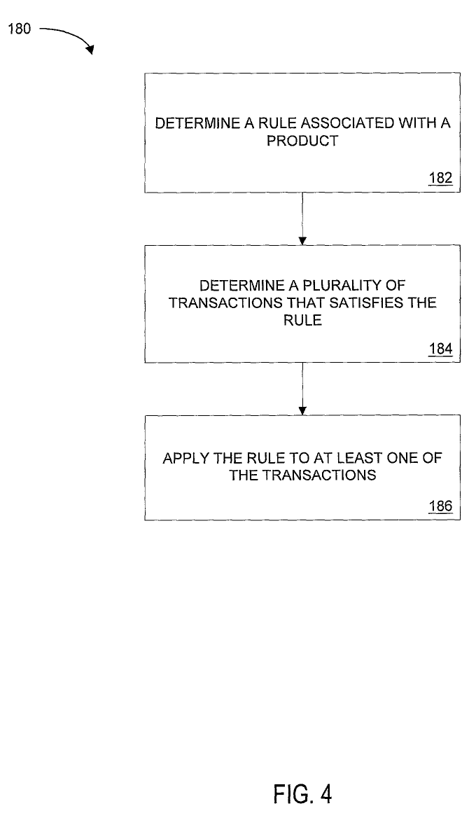

Reference is now made to FIG. 4, where a flow chart 180 is shown which represents the operation of a fourth embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be implemented by a server or other device on behalf of one or more entities.

Processing begins at a step 182 where a rule associated with a product is determined. The step 182 may occur before, during or after a transaction involving the product. In some embodiments, the step 182 may include receiving a message or notification that the transaction is occurring or has occurred. In some embodiments the step 182 may include receiving a notification of an identifier associated with the transaction or the product to enable a search for additional information in a product or rule database.

During a step 184, a plurality of transactions is identified that satisfies the rule determined during the step 182. For example, a rule determined during the step 182 may require five different transactions to occur or expected to occur before the rule can be applied to any one or more of the transactions. As another example, a rule determined during the step 182 may require a cumulative total of a product to be purchased during a two-month time period. Thus, the step 184 may include identifying enough transactions during the designated time period to satisfy the rule. As a third example, a rule may require particular attachments or accessories to a product to be purchased before a price discount can be applied to the product. The step 184 may include identifying those transactions that involved the required purchase of the attachments or accessories.

During a step 186, the rule determined during the step 182 is applied to one or more of the transactions identified during the step 184. In some embodiments, application of the rule during the step 186 may involve providing a retroactive discount, credit or other benefit or result to one or more transactions.

In some embodiments, the method 180 may include a step of associating a plurality of rules to a plurality of products. In other embodiments, the method 180 may include providing a notification or the rule determined during the step 182 or one or more of the transactions determined during the step 184.

In addition to the methods 100, 120, 160 and 180 discussed above, other possible implementations of the method of the present invention are also possible. For example, a method for conducting or otherwise facilitating a transaction might associating a plurality of rules with a respective plurality of entities in a manner similar to the step 102; receiving a notification of a transaction involving one of the plurality of entities; determining one of the plurality of rules that is associated with the transaction in a manner similar to the step 106; and providing a notification of one of the plurality of rules. As another alternative example, a method for conducting or otherwise facilitating a transaction may include associating a first rule governing a first transaction with a first entity and a second rule governing a second transaction with a second entity in a manner similar to the steps 122, 124; receiving a notification of the first entity conducting the first transaction; and applying the first rule when the first entity conducts the first transaction. In addition, the method might include receiving a notification of the second entity conducting the second transaction; and applying the second rule when the second entity conducts the second transaction.

System

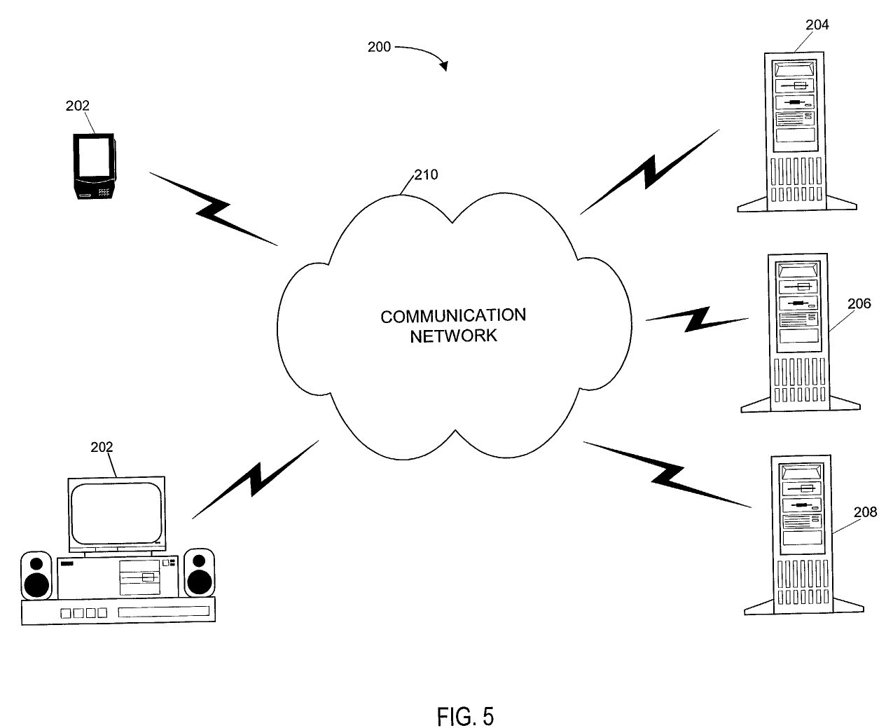

Now referring to FIG. 5, an apparatus or system 200 usable with the methods disclosed herein is illustrated. The apparatus 200 includes one or more user or client devices 202 that may communicate directly or indirectly with one or more servers, controllers or other devices 204, 206, 208 via a computer, data, or communications network 210. A server may implement of the methods discussed above on behalf of one or more entities involved or monitoring a transaction, group of transactions or marketplace activity. A server, such as the server 204, may receive notifications from and/or send notifications to a user device or one of the other servers.

A server may implement or host a Web site. A server can comprise a single device or computer, a networked set or group of devices or computers, a workstation, etc. In some embodiments, a server also may function as a database server and/or as a user device. The use, configuration and operation of servers will be discussed in more detail below.

The user devices 202 preferably allow entities to interact with the server 204 and the remainder of the apparatus 200. The user devices 202 also may enable an entity to access Web sites, software, marketplaces, databases, etc. hosted or operated by the servers 202. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, etc.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone or communications network or intranet, as will be described in further detail below. The communications network 210 illustrated in FIG. 5 is only meant to be generally representative of cable, computer, telephone or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 204 without departing from the scope of the present invention. Moreover, as used herein, communications include those enabled by wired or wireless technology.

In some embodiments, a suitable wireless communication network 210 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 5 may be equipped with a microchip transceiver that transmits and receives in a previously unused frequency band of 2.45 GHz that is available globally (with some variation of bandwidth in different countries). In addition to data, up to three voice channels are available. Connections can be point-to-point or multipoint over a current maximum range of ten (10) meters. Embodiments using Bluetooth technology may require the additional use of one or more receiving stations to receive and forward data from individual user devices 202 or servers 204.

Although three user or client devices 202 and three servers 204 are shown in FIG. 5, any number of such devices may be included in the system 200. The devices shown in FIG. 5 need not be in constant communication. For example, a user device may communicate with a server only when such communication is appropriate or necessary.

Server

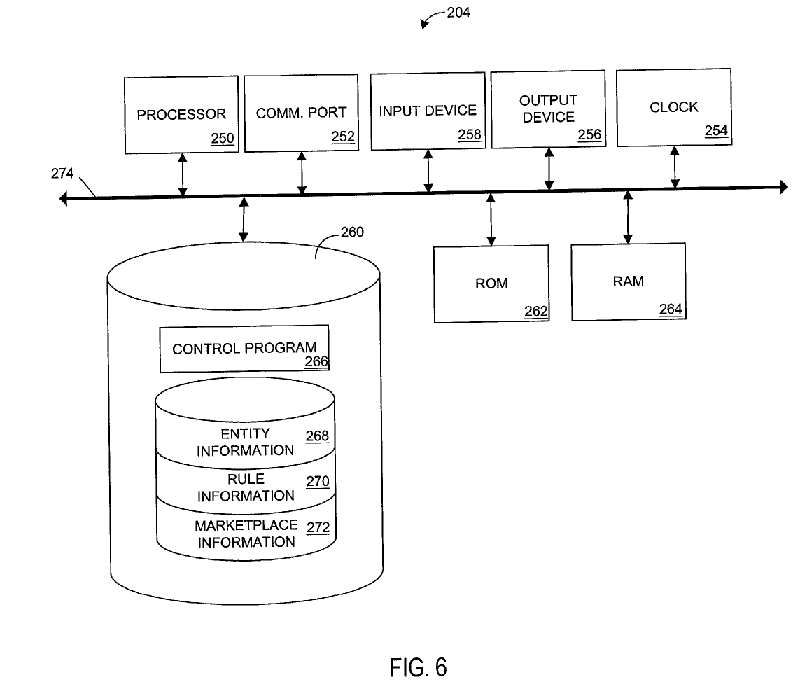

Now referring to FIG. 6, a representative block diagram of a server or controller 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, rules, communications or other notifications, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 262 and RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding entities, notifications, products, transactions, marketplaces, etc. For example, information regarding one or more entities may be stored in an entity database 268 for use by the server 204 or another device or entity, information regarding one or more rules may be stored in a rule database 270 for use by the server 204 or another device or entity, and information regarding one or more marketplaces may be store in a marketplace database 272 for used by the server 204 or another device or entity.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 274.

While specific implementations and hardware configurations for servers 204 devices have been illustrated, it should be noted that other implementations and hardware configurations are possible and that no specific implementation or hardware configuration is needed. Thus, not all of the components illustrated in FIG. 5 may be needed for a server implementing the methods disclosed herein. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. If desired, the user device 202 also may function as a server 204. In some embodiments, a user device 202 may have the same structure or configuration as the server 204 illustrated in FIG. 6 and some or all of the components of the server 204.

Databases

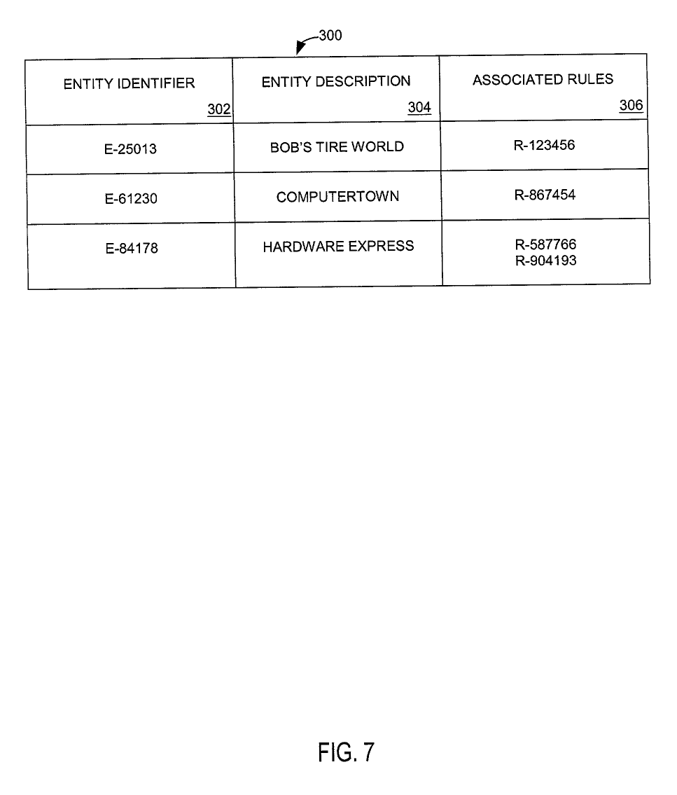

As previously discussed above, in some embodiments a server, user device, or other device may include or access an entity database for storing or keeping information regarding one or more entities that might conduct a transaction or participate in a transaction. One representative entity database 300 is illustrated in FIG. 7.

The entity database 300 may include an entity identifier field 302 that may include codes or other identifiers for one or more entities, an entity description field 304 that may include names, descriptions and other information associated with the entities identified in the field 302, and an associated rules field 306 that may include codes or other identifiers for one or more rules associated with the entities identified in the field 302. Other or different fields also may be used in the entity database 300. For example, the entity database 300 may include fields containing address or other contact information for the entities identified in the field 302 and/or fields containing information regarding the interests, demographics, preferences, etc. of the entities identified in the field 302.

As illustrated in the representative entity database 300 of FIG. 7, the entity identified as “E-25013” in the field 302 is named “BOB'S TIRE WORLD” and is associated with a rule identified as “R-123456”. Information regarding rules may be found in a rules database, as will be discussed in more detail below.

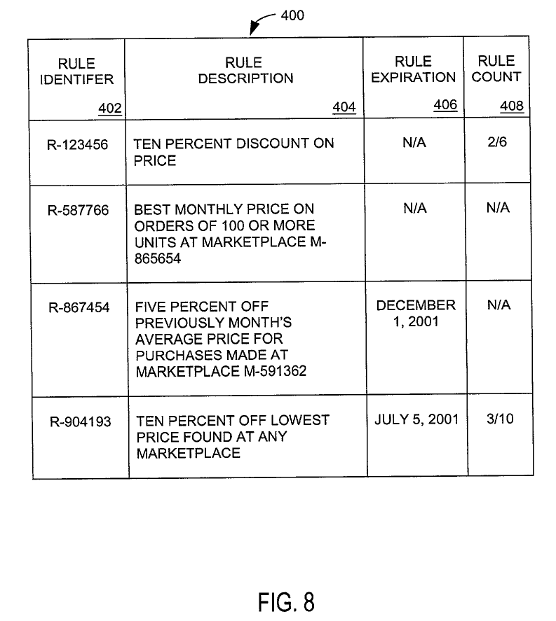

As previously discussed above, in some embodiments a server, user device, or other device may include or access a rule database for storing or keeping information regarding one or more rules. One representative rule database 400 is illustrated in FIG. 8.

The rule database 400 may include a rule identifier field 402 that includes codes or identifiers for one or more rules associated with entities and/or marketplaces; a rule description field 404 that includes names, descriptions and or other information associated with the rules identified in the field 402; a rule expiration field 406 that may include rule expiration information that may apply to some or all of the rules identified in the field 402; and a rule count information field 408 that may include information regarding the use of the rules identified in the field 402. Other or different fields also may be used in the rule database 400. For example, the rule database 400 may include entity identifiers for entities associated with the rules identified in the field 402 and/or marketplace identifiers for marketplaces associated with the rules identified in the field 402. As a more specific example, the rule database 400 may include a marketplace identifier that associates the rule identified as “R-123456” with a marketplace identified as “M-223436”, thereby indicating that the rule “R-123456” is usable at the marketplace “M-223436”.

As illustrated in the representative rule database 400 of FIG. 8, the rule identified as “R-123456” in the field 402 allows an entity to receive a ten percent (10%) discount for a transaction. The rule “R-123456” does not have an expiration date, as indicated by the entry in the field 406, but can only be used six times, as indicated by the entry in the field 408. The rule “R-123456” has been used two times so far, as indicated by the entry in the field 408.

The rule identified as “R-587766” in the field 402 allows an entity to receive the best price available during the month preceding the transaction if the entity orders one hundred or more units of a product. The rule identified as “R-867454” in the field 402 allows an entity to receive a price for a product that is five percent (5%) less than the previous monthly average price if the entity purchases the product at the marketplace identified as “M-591362”. The rule “R-867454” expires on Dec. 1, 2001.

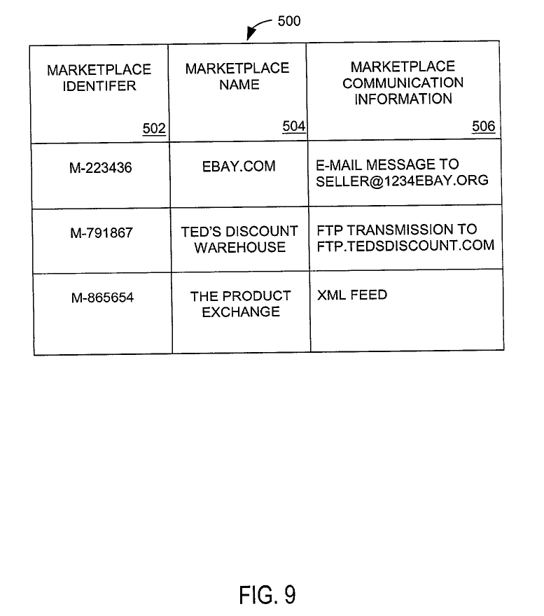

As previously discussed above, in some embodiments a server, user device, or other device may include or access a marketplace database for storing or keeping information regarding one or more marketplaces. One representative marketplace database 500 is illustrated in FIG. 9.

The marketplace database 500 may include a marketplace identifier field 502 that may include codes or other identifiers for one or more marketplaces, a marketplace name/description field 504 that may include names, descriptions and other information for the marketplaces identified in the field 502, and a marketplace communication information field 506 that may include information regarding how to contract or communicate with the marketplaces identified in the field 506. Other or different fields also may be used in the marketplace database 500. For example, the marketplace database 500 may include fields that include information regarding terms and conditions required by the marketplaces identified in the field 502, fields that include information regarding the hours of availability of the marketplaces identified in the field 502, fields that include rule identifiers associated with the marketplaces identified in the field 502, field that include entity identifiers associated with the marketplaces identified in the field 502, etc.

As illustrated in the representative marketplace database 500 of FIG. 9, the marketplace identified as identified as “M-223436” in the field 502 is named “EBAY.COM”. Communication with the marketplace “M-123456” can occur by sending an email message to “SELLER@1234EBAY.COM” as indicated in the field 506.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Each of the methods disclosed herein may be used in many different industries, including, but not limited to, the semiconductor, automotive, electronics, data processing, mining, chemical, petroleum, aerospace, plastics manufacturing, medical device and technologies, consumer, food processing, and commodities industries. In some embodiments, one or more of the methods disclosed herein may be limited to use with certain kinds or types of products (e.g., non-financial products, dynamically priced products, semiconductor products).

Although the present invention has been described with respect to a preferred embodiment thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for conducting a transaction, comprising:
associating a plurality of distinct rules with a respective plurality of distinct entities;
contemporaneously with or after said associating a plurality of distinct rules with a plurality of distinct entities, determining that one of said plurality of entities is conducting a transaction;
determining a rule from said plurality of rules that is associated with said one of said plurality of entities regarding said transaction; and
conducting said transaction in accordance with said rule.

2. The method of claim 1, wherein said rule is based, at least in part, on at least one of the following:
a barter credit;
a spot price for a product;
a price of a product involved in said transaction;
a minimum number of products purchased during said transaction;
a maximum number of products purchased during said transaction;
a payment term associated with said transaction;
a delivery requirement associated with said transaction;
a shipping requirement associated with said transaction;
a quality requirement for a product involved in said transaction;
bundled products associated with said transaction;
a customer associated with said transaction;
an amount of inventory of a product involved in said transaction; and
availability of a product involved in said transaction.

3. The method of claim 1, wherein said determining a rule from said plurality of rules includes at least one of the following:
determining an identifier associated with said one of said plurality of entities; and
receiving a notification of said rule.

4. The method of claim 1, wherein said conducting said transaction in accordance with said rule includes at least one of the following:
determining a product involved in said transaction;
determining a spot price for a product;
determining a price for a product involved in said transaction;
applying a barter credit to said transaction;
applying a predetermined credit term to said transaction;
applying a predetermined payment term to said transaction;
applying a predetermined discount to said transaction;
selling a non-financial product;
purchasing a non-financial product;
selling a dynamically priced product;
purchasing a dynamically priced product;
determining an average price for a product over a designated period of time;
determining a minimum price for a product over a designated period of time;
determining a maximum price for a product over a designated period of time;
applying a function of market prices for a product over a designated period of time for said product when said product is involved in said transaction;
providing a fulfillment priority to said transaction;
determining logistics terms for said transaction;
providing a designated price to a product involved in said transaction;
providing a notification of said rule; and
providing an authorization to conduct said transaction.

5. The method of claim 1, wherein said determining that one of said plurality of entities is conducting a transaction includes receiving a notification that one of said plurality of entities is conducting a transaction.

6. The method of claim 5, wherein said receiving a notification that one of said plurality of entities is conducting a transaction includes at least one of the following:
receiving said notification from a user device;
receiving said notification from a server;
receiving said notification from a device associated with a marketplace;
receiving an electronic communication via a communications network;
receiving a notification of a marketplace involved in said transaction;
receiving said notification from said entity;
receiving said notification from a marketplace involved in said transaction; and
receiving said notification from a party other than said entity involved in said transaction.

7. The method of claim 5, wherein said notification comprises at least one of the following:
an email message;
an XML feed;
an HTTP transmission;
an HTML transmission;
an FTP transmission;
a wireless transmission;
an instant message communication;
an electronic communication sent via a communications network;
a facsimile transmission;
a telephone signal; and
a radio signal.

8. The method of claim 1, wherein said associating a plurality of rules with a respective plurality of entities includes at least one of the following:
determining at least one rule that will apply for an entity conducting a transaction; and
receiving a notification of a rule to associate with one of said plurality of entities.

9. The method of claim 1, further comprising:
providing a notification regarding said transaction to a marketplace.

10. The method of claim 1, further comprising:
providing a notification regarding said transaction to said one of said plurality of entities.

11. The method of claim 1, wherein said rule includes a condition and a result.

12. The method of claim 11, wherein said conducting said transaction includes determining if said condition is satisfied.

13. The method of claim 12, wherein said conducting said transaction includes providing said result if said condition is satisfied.

14. The method of claim 12, wherein said conducting said transaction includes providing a notification that said condition is satisfied.

15. The method of claim 11, wherein said condition includes at least one of the following:
a requirement that a minimum number of products be purchased as part of said transaction;
a requirement of a predetermined lead time between said transaction and delivery of a product involved in said transaction;
a requirement of a predetermined lead time between said transaction and shipping of a product involved in said transaction;
a requirement of a cumulative transactional volume over a designated time period;
a requirement of a cumulative transactional volume by said one of said plurality of entities;
a requirement of a cumulative transactional volume at a designated marketplace;
a requirement of an availability of a product involved in said transaction;
a requirement that a specific entity be involved in said transaction;
a requirement that a specific marketplace be involved in said transaction;
a requirement that a specific marketplace not be involved in said transaction;
a requirement that a specific entity not be involved in said transaction;
a requirement for an insurance policy associated with said transaction;
a requirement that a specific product be bundled with said transaction;
a requirement of a minimum financial amount involved in said transaction; and
a requirement of a designated security associated with said transaction.

16. The method of claim 1, wherein said transaction involves at least one of the following:
a dynamically priced product; and
a non-financial product.

17. The method of claim 1, further comprising:
determining a charge associated with at least one of said associating a plurality of rules with a respective plurality of entities, said receiving a notification that one of said plurality of entities is conducting a transactions, said determining a rule from said plurality of rules that is associated with said one of said plurality of entities, and said conducting said transaction.

18. The method of claim 17, further comprising:
providing a notification of said charge.

19. The method of claim 17, wherein said charge is based, at least in part, on at least one of the following:
a monetary amount involved in said transaction;
a non-financial product involved in said transaction;
a dynamically priced product involved in said transaction;
an anticipated cost savings associated with said transaction;
a realized cost savings associated with said transaction;
a cost associated with said transaction relative to a benchmark;
an anticipated benefit associated with said transaction;
a realized benefit associated with said transaction;
a benefit associated with said transaction relative to a benchmark;
a delivery requirement associated with said transaction;
a financial requirement associated with said transaction;
a number of entities in said plurality of entities;
a number of rules in said plurality of rules,
a number of products involved in said transaction;
a number of times said rule from said plurality of rules has been applied in previous transactions;
a number of times said entity from said plurality of entities has been involved in previous transactions; and
a marketplace involved in said transaction.

20. The method of claim 1, further comprising:
modifying said rule from said plurality of rules.

21. The method of claim 20, wherein said modifying said rule from said plurality of rules occurs after said conducting said transaction in accordance with said rule.

22. A method for facilitating a transaction, comprising:
associating a first rule governing a first transaction with a first entity, wherein a first marketplace will honor said first rule when said first entity conducts said first transaction at said first marketplace;
associating a second rule governing a second transaction with a second entity, wherein a second marketplace will honor said second rule when said second entity conducts said second transaction at said second marketplace; and
authorizing application of said first rule when said first entity conducts said firsts transaction at said first marketplace and application of said second rule when said second entity conducts said second transaction at said second marketplace.

23. The method of claim 22, wherein said first rule includes a condition and a result.

24. The method of claim 23, wherein said applying said first rule includes determining if said condition is met.

25. The method of claim 23, wherein said applying said first rule includes providing said result if said condition is met.

26. The method of claim 22, wherein said first marketplace and said second marketplace are the same but said first rule and said second rule are different.

27. The method of claim 22, wherein said first marketplace and said second marketplace are different but said first rule is the same as said second rule.

28. The method of claim 22, further comprising:
receiving a notification when said first entity initiates said first transaction.

29. The method of claim 28, further comprising:
receiving a notification when said second entity initiates said second transaction.

30. The method of claim 22, wherein said first transaction involves at least one of the following:
a dynamically priced product; and
a non-financial product.

31. A method for facilitating a transaction, comprising:
associating a plurality of rules with a respective plurality of entities;
receiving a notification of a transaction involving one of said plurality of entities;
determining one of said plurality of rules that is associated with said transaction; and
providing a notification of said one of said plurality of rules.

32. The method of claim 31, wherein said providing a notification of said one of said plurality of rules includes at least one of the following:
providing said notification to a marketplace; and
providing said notification to one of said plurality of entities.

33. The method of claim 31, wherein said transaction involves at least one of the following:
a dynamically priced product; and
a non-financial product.

34. A method for conducting a transaction, comprising:
associating a first rule governing a first transaction with a first entity and a second rule governing a second transaction with a second entity;
receiving a notification of said first entity conducting said first transaction; and
applying said first rule when said first entity conducts said first transaction.

35. The method of claim 34, further comprising:
receiving a notification of said second entity conducting said second transaction.

36. The method of claim 35, further comprising:
applying said second rule when said second entity conducts said second transaction.

37. The method of claim 34, wherein said first transaction involves at least one of the following:
a dynamically priced product; and
a non-financial product.

38. A method for facilitating a transaction, comprising:
receiving a notification of a transaction involving a product;
determining a rule that is associated with said transaction; and
providing a notification of said rule.

39. A method for facilitating a transaction, comprising:
determining a rule associated with at least one product;
determining a plurality of transactions that satisfies said rule; and
applying said rule to at least one of said plurality of transactions.

40. The method of claim 39, wherein said determining a rule associated with at least one product includes at least one of the following:
receiving a notification regarding said rule; and
receiving a notification of an identifier associated with said rule,

41. The method of claim 39, wherein said applying said rule to at least one of said plurality of transactions includes at least one of the following:
applying a barter credit to said at least one transaction;
applying a predetermined credit term to said at least one transaction;
applying a predetermined payment term to said at least one transaction;
applying a predetermined discount to said at least one transaction;
selling a non-financial product in accordance with said rule;
purchasing a non-financial product in accordance with said rule;
selling a dynamically priced product in accordance with said rule;
purchasing a dynamically priced product in accordance with said rule;
determining an average price for a product over a designated period of time and applying said average price to said at least one transaction;
determining a minimum price for a product over a designated period of time and applying said minimum price to said at least one transaction;
determining a maximum price for a product over a designated period of time and applying said maximum price to said at least one transaction;
applying a function of market prices for a product over a designated period of time for said product when said product is involved in said at least one transaction;
providing a payment to an entity conducting at least one of said plurality of transactions;
applying a price discount retroactively to at least one of said plurality of transactions; and
providing a designated price to a product involved in said at least one transaction.

42. The method of claim 39, further comprising:
providing a notice of said applying said rule to at least one of said plurality of transactions.

43. The method of claim 39, wherein at least one of said plurality of transactions occurs prior to said determining a plurality of transactions that satisfies said rule.

44. The method of claim 39, wherein all said plurality of transactions occur prior to said determining a plurality of transactions that satisfies said rule.

45. The method of claim 39, wherein at least one of said plurality of transactions occurs after said determining a plurality of transactions that satisfies said rule.

46. A system for facilitating a transaction, comprising:
a memory;
a communication port; and
a processor connected to said memory and said communication port, said processor being operative to:
associate a plurality of rules with a respective plurality of entities;
determine that one of said plurality of entities is conducting a transaction;
determine a rule from said plurality of rules that is associated with said one of said plurality of entities regarding said transaction; and
authorize said transaction in accordance with said rule.

47. A computer program product in a computer readable medium for facilitating a transaction, comprising:
first instructions for establishing a respective rule for each of a plurality of entities;
second instructions for identifying one of said plurality of entities conducting a transaction;
third instructions for identifying a rule associated with said one of said plurality of entities; and
fourth instructions for sending an authorization of said transaction in accordance with said rule.
